(19) United States
(12) Patent Application Publication
(10) Pub. No.: US 2016/0305134 A1
(43) Pub. Date: Oct. 20, 2016

(54) LOOSEFILL INSULATION BLOWING MACHINE HAVING A COMPACT SIZE AND REDUCED WEIGHT

(71) Applicant: Owens Corning Intellectual Capital, LLC, Toledo, OH (US)

(72) Inventors: David M. Cook, Granville, OH (US); Todd Jenkins, Newark, OH (US); Thomas J. McNamee, III, Perrysburg, OH (US); Brandon Robinson, Sylvania, OH (US); Fawn Uhl, New Albany, OH (US); Joseph Wagner, Perrysburg, OH (US); Ryan S. Crisp, Lewis Center, OH (US); Christopher S. Daniels, Columbus, OH (US); Shannon D. Staats, Ostrander, OH (US)

(73) Assignee: Owens Corning Intellectual Capital, LLC, Toledo, OH (US)

(21) Appl. No.: 15/079,856

(22) Filed: Mar. 24, 2016

Related U.S. Application Data
(60) Provisional application No. 62/147,001, filed on Apr. 14, 2015.

(51) Int. Cl. E04F 21/08; B02C 18/22

(52) U.S. Cl. CPC E04F 21/085; B02C 18/2291; B02C 18/2216

(57) ABSTRACT

A machine for distributing blowing insulation material from a package of compressed loosefill insulation material is provided. The machine includes a chute having an inlet portion and outlet portion. The inlet portion is configured to receive the package of compressed loosefill insulation material with the package having a substantially vertical orientation. The chute has a volumetric size. A lower unit is configured to receive the compressed loosefill insulation material exiting the outlet portion of the chute. The lower unit includes a plurality of shredders and a discharge mechanism. The discharge mechanism is configured to discharge conditioned loosefill insulation material into an airstream. The lower unit has a volumetric size. The machine has a volumetric size equal to the total of a volumetric size of the chute and the volumetric size of the lower unit, and wherein the machine has a maximum volumetric size of 12.0 cubic feet.

### RELATED APPLICATIONS

This application claims priority from pending U.S. Provisional Patent Application No. 62/147,001, filed Apr. 14, 2015, the disclosure of which is incorporated herein by reference in its entirety.

### BACKGROUND

When insulating buildings and installations, a frequently used insulation product is loosefill insulation material. In contrast to the unitary or monolithic structure of insulation materials formed as batts or blankets, loosefill insulation material is a multiplicity of discrete, individual tufts, cubes, flakes or nodules. Loosefill insulation material is usually applied within buildings and installations by blowing the loosefill insulation material into an insulation cavity, such as a wall cavity or an attic of a building. Typically loosefill insulation material is made of glass fibers although other mineral fibers, organic fibers, and cellulose fibers can be used.

Loosefill insulation material, also referred to as blowing wool, is typically compressed in packages for transport from an insulation manufacturing site to a building that is to be insulated. Typically the packages include compressed loosefill insulation material encapsulated in a bag. The bags can be made of polypropylene or other suitable material. During the packaging of the loosefill insulation material, it is placed under compression for storage and transportation efficiencies. Typically, the loosefill insulation material is packaged with a compression ratio of at least about 10:1.

The distribution of loosefill insulation material into an insulation cavity typically uses an insulation blowing machine that can condition the loosefill insulation material to a desired density and feed the conditioned loosefill insulation material pneumatically through a distribution hose. Blowing insulation machines typically have a funnel-shaped chute or hopper for containing and feeding the blowing insulation material after the package is opened and the blowing insulation material is allowed to expand.

It would be advantageous if insulation blowing machines could be improved to make them easier to use.

### SUMMARY

The above objects as well as other objects not specifically enumerated are achieved by a machine for distributing blowing insulation material from a package of compressed loosefill insulation material. The machine includes a chute having an inlet portion and outlet portion. The inlet portion is configured to receive the package of compressed loosefill insulation material with the package having a substantially vertical orientation. The chute has a volumetric size. A lower unit is configured to receive the compressed loosefill insulation material exiting the outlet portion of the chute. The lower unit includes a plurality of shredders and a discharge mechanism. The discharge mechanism is configured to discharge conditioned loosefill insulation material into an airstream. The lower unit has a volumetric size. The machine has a volumetric size equal to the total of a volumetric size of the chute and the volumetric size of the lower unit, and wherein the machine has a maximum volumetric size of 12.0 cubic feet.

There is also provided a machine for distributing blowing insulation material from a package of compressed loosefill insulation material. The machine includes a chute having an inlet portion and outlet portion. The inlet portion is configured to receive the package of compressed loosefill insulation material with the package having a substantially vertical orientation. The chute has a weight. A lower unit is configured to receive the compressed loosefill insulation material exiting the outlet portion of the chute. The lower unit includes a plurality of shredders and a discharge mechanism. The discharge mechanism is configured to discharge conditioned loosefill insulation material into an airstream. The lower unit has a weight. The machine has a weight equal to the total of the weight of the chute and the weight of the lower unit and the machine has a maximum weight in a range of from about 90.0 pounds to about 110.0 pounds

Various objects and advantages of the loosefill insulation blowing machine having a compact size and a reduced weight will become apparent to those skilled in the art from the following detailed description, when read in light of the accompanying drawings.

### BRIEF DESCRIPTION OF THE DRAWINGS

FIG. 1 is a front view, in elevation, of a loosefill insulation blowing machine

FIG. 2 is a front view, in elevation, partially in cross-section, of the loosefill insulation blowing machine of FIG. 1.

FIG. 3 is a side view, in elevation, of the loosefill insulation blowing machine of FIG. 1.

### DETAILED DESCRIPTION OF THE INVENTION

The loosefill insulation blowing machine having a compact size and reduced weight will now be described with occasional reference to specific embodiments. The loosefill insulation blowing machine having a compact size and reduced weight may, however, be embodied in different forms and should not be construed as limited to the embodiments set forth herein. Rather, these embodiments are provided so that this disclosure will be thorough and complete, and will fully convey the scope of the loosefill insulation blowing machine having a compact size and reduced weight to those skilled in the art.

Unless otherwise defined, all technical and scientific terms used herein have the same meaning as commonly understood by one of ordinary skill in the art to which the loosefill insulation blowing machine having a compact size and reduced weight belongs. The terminology used in the description of the loosefill insulation blowing machine having a compact size and reduced weight herein is for describing particular embodiments only and is not intended to be limiting of the loosefill insulation blowing machine having a compact size and reduced weight. As used in the description of the loosefill insulation blowing machine having a compact size and reduced weight and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the loosefill insulation blowing machine having a compact size and reduced weight. Notwithstanding that the numerical ranges and parameters setting forth the broad scope of the loosefill insulation blowing machine having a compact size and reduced weight are approximations, the numerical values set forth in the specific examples are reported as precisely as possible. Any numerical values, however, inherently contain certain errors necessarily resulting from error found in their respective measurements.

The description and figures disclose a loosefill insulation blowing machine having a compact size and reduced weight. The compact size and reduced weight of the blowing machine provide a user with enhanced ability to transport and position the blowing machine for increased efficiency during installation of conditioned loosefill insulation material.

The term “loosefill insulation material”, as used herein, is defined to mean any insulating material configured for distribution in an airstream. The term “finely conditioned”, as used herein, is defined to mean the shredding, picking apart and conditioning of loosefill insulation material to a desired density prior to distribution into an airstream.

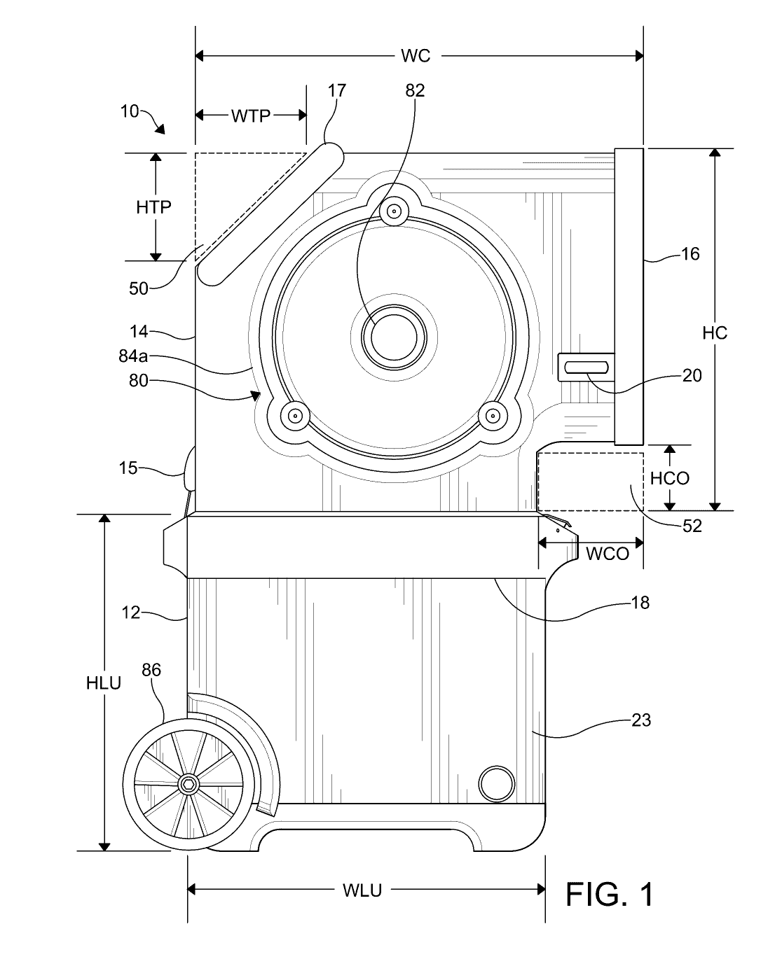

Referring now to FIGS. 1-3, a loosefill insulation blowing machine (hereafter “blowing machine”) is shown generally at 10. The blowing machine 10 is configured for conditioning compressed loosefill insulation material and further configured for distributing the conditioned loosefill insulation material to desired locations, such as for example, insulation cavities. The blowing machine 10 includes a lower unit 12 and a chute 14. The lower unit 12 is connected to the chute 14 by one or more fastening mechanisms 15, configured to readily assemble and disassemble the chute 14 to the lower unit 12. The chute 14 has an inlet portion 16 and an outlet portion 18.

Referring again to FIGS. 1-3, the inlet portion 16 of the chute 14 is configured to receive compressed loosefill insulation material typically contained within a package (not shown). As the package of compressed loosefill insulation material is guided into an interior of the chute 14, the cross-sectional shape and size of the chute 14 relative to the cross-sectional shape and size of the package of compressed loosefill insulation material directs the expansion of the compressed loosefill insulation material to a direction toward the outlet portion 18, wherein the loosefill insulation material is introduced to a shredding chamber 23 positioned in the lower unit 12.

Referring again to FIGS. 1-3, optionally the chute 14 can include one or more handle segments 17, configured to facilitate ready movement of the blowing machine 10 from one location to another. The handle segment 17 can have any desired structure and configuration. However, it should be understood that the one or more handle segments 17 are not necessary to the operation of the blowing machine 10.

Referring again to FIGS. 1-3, the chute 14 includes a bail guide 19, mounted at the inlet portion 16 of the chute 14. The bail guide 19 is configured to urge a package of compressed loosefill insulation material against an optional cutting mechanism 20 as the package of compressed loosefill insulation material moves further into the interior of the chute 14. The cutting mechanism 20 can have any desired structure and configuration. However, it should be understood that the bail guide 19 and the cutting mechanism 20 are not necessary to the operation of the blowing machine 10.

Referring again to FIGS. 1-3, the chute 14 includes a distribution hose storage structure 80. The distribution hose storage structure 80 is configured to store a distribution hose 38 within the chute 14 in the event the blowing machine 10 is not in use. The distribution hose storage structure 80 includes a hose hub 82 attached to flanges 84a, 84b, with each of the flanges 84a, 84b being mounted in opposing sides of the chute 14.

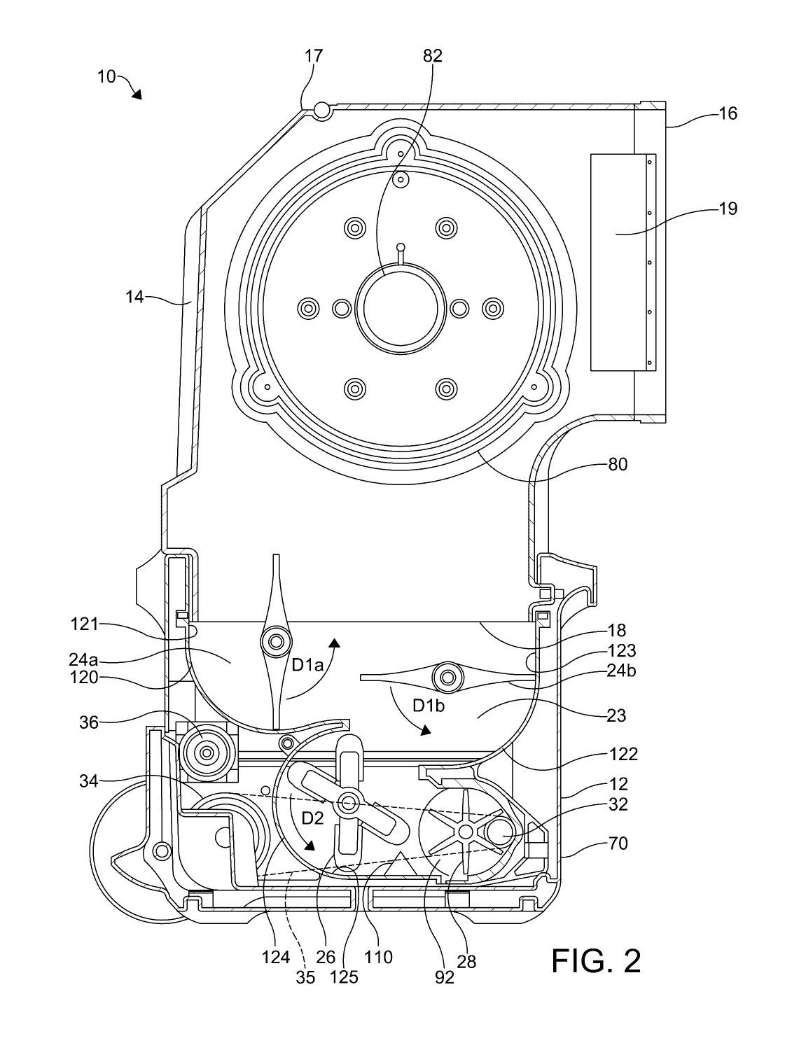

Referring now to FIG. 2, the shredding chamber 23 is mounted in the lower unit 12, downstream from the outlet portion 18 of the chute 14. The shredding chamber 23 can include a plurality of low speed shredders 24a, 24b and one or more agitators 26. The low speed shredders 24a, 24b are configured to shred, pick apart and condition the loosefill insulation material as the loosefill insulation material is discharged into the shredding chamber 23 from the outlet portion 18 of the chute 14. The one or more agitators 26 are configured to finely condition the loosefill insulation material to a desired density as the loosefill insulation material exits the low speed shredders 24a, 24b. It should be appreciated that any quantity of low speed shredders and agitators can be used. Further, although the blowing machine 10 is described with low speed shredders and agitators, any type or combination of separators, such as clump breakers, beater bars or any other mechanisms, devices or structures that shred, pick apart, condition and/or finely condition the loosefill insulation material can be used.

Referring again to the embodiment shown in FIG. 2, the agitator 26 is positioned vertically below the low speed shredders 24a, 24b. Alternatively, the agitator 26 can be positioned in any location relative to the low speed shredders 24a, 24b, such as horizontally adjacent to the low speed shredders 24a, 24b, sufficient to finely condition the loosefill insulation material to a desired density as the loosefill insulation material exits the low speed shredders 24a, 24b.

In the embodiment illustrated in FIG. 2, the low speed shredders 24a, 24b rotate in a counter-clockwise direction, as shown by direction arrows D1a, D1b and the one or more agitators 26 also rotate in a counter-clockwise direction, as shown by direction arrow D2. Rotating the low speed shredders 24a, 24b and the agitator 26 in the same counter-clockwise directions, D1a, D1b and D2, allows the low speed shredders 24a, 24b and the agitator 26 to shred and pick apart the loosefill insulation material while substantially preventing an accumulation of unshredded or partially shredded loosefill insulation material in the shredding chamber 23. However, in other embodiments, the low speed shredders 24a, 24b and the agitator 26 could rotate in a clock-wise direction or the low speed shredders 24a, 24b and the agitator 26 could rotate in different directions provided an accumulation of unshredded or partially shredded loosefill insulation material does not occur in the shredding chamber 23.

Referring again to the embodiment shown in FIG. 2, the low speed shredders 24a, 24b rotate at a lower rotational speed than the agitator 26. The low speed shredders 24a, 24b rotate at a speed of about 40-80 revolutions per minute (rpm) and the agitator 26 rotates at a speed of about 300-500 rpm. In another embodiment, the low speed shredders 24a, 24b can rotate at a speed less than about 40-80 rpm, provided the speed is sufficient to shred and pick apart the loosefill insulation material. In still other embodiments, the agitator 26 can rotate at a speed less than or more than 300-500 rpm provided the speed is sufficient to finely shred the loosefill insulation material and prepare the loosefill insulation material for distribution into an airstream.

Referring again to FIG. 2, the shredding chamber 23 includes a first guide shell 120 positioned partially around the low speed shredder 24a. The first guide shell 120 extends to form an arc of approximately 90°. The first guide shell 120 has an inner surface 121. The first guide shell 120 is configured to allow the low speed shredder 24a to seal against the inner surface 121 and thereby direct the loosefill insulation material in a downstream direction as the low speed shredder 24a rotates.

Referring again to FIG. 2, the shredding chamber 23 includes a second guide shell 122 positioned partially around the low speed shredder 24b. The second guide shell 122 extends to form an arc of approximately 90°. The second guide shell 122 has an inner surface 123. The second guide shell 122 is configured to allow the low speed shredder 24b to seal against the inner surface 123 and thereby direct the loosefill insulation material in a downstream direction as the low speed shredder 24b rotates.

Referring again to FIG. 2, the shredding chamber 23 includes a third guide shell 124 positioned partially around the agitator 26. The third guide shell 124 extends to form an approximate semi-circle. The third guide shell 124 has an inner surface 125. The third guide shell 124 is configured to allow the agitator 26 to seal against the inner surface 125 and thereby direct the finely conditioned loosefill insulation material in a downstream direction as the agitator 26 rotates.

In the embodiment shown in FIG. 2, the inner surfaces 121, 123 and 125, are formed from a high density polyethylene material (hdpe) configured to provide a lightweight, low friction sealing surface and guide for the loosefill insulation material. Alternatively, the inner surfaces 121, 123 and 125 can be formed from other materials, such as aluminum, sufficient to provide a lightweight, low friction sealing surface and guide that allows the low speed shredders 24a, 24b and the agitator 26 to direct the loosefill insulation material downstream.

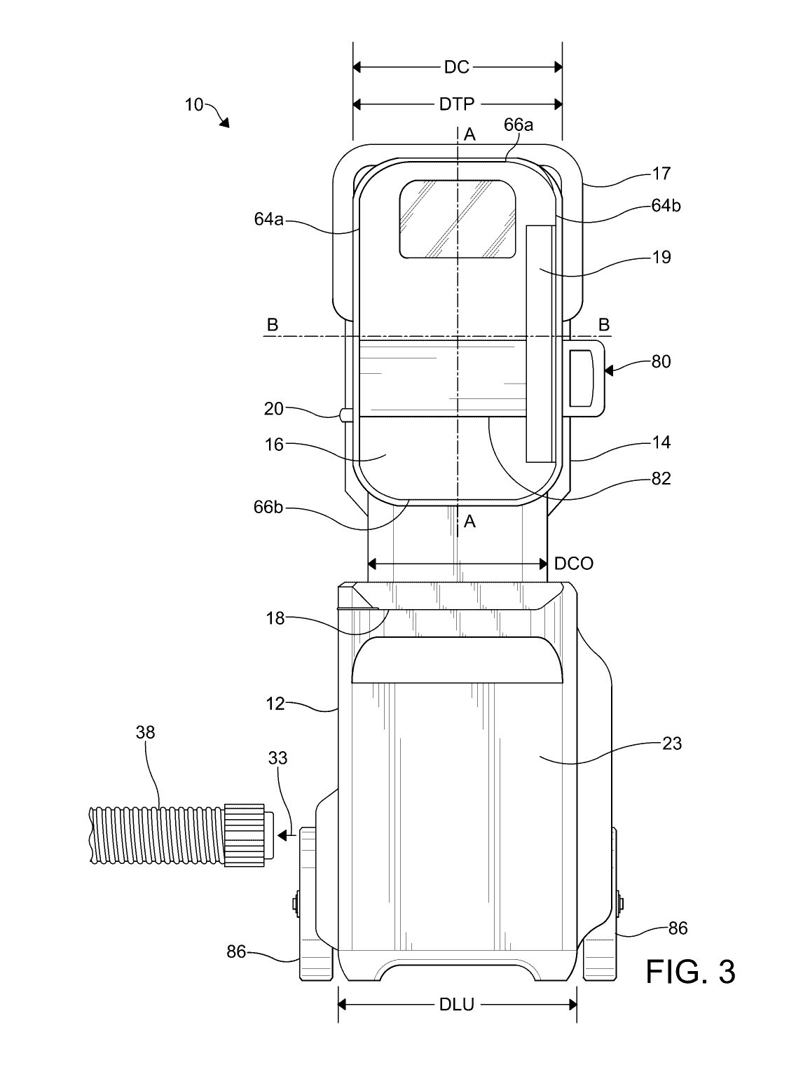

Referring again to FIG. 2, a discharge mechanism, shown schematically at 28, is positioned downstream from the one or more agitators 26 and is configured to distribute the finely conditioned loosefill insulation material exiting the agitator 26 into an airstream, shown schematically by arrow 33 in FIG. 3. In the illustrated embodiment, the discharge mechanism 28 is a rotary valve. In other embodiments, the discharge mechanism 28 can be other structures, mechanisms and devices, such as for example staging hoppers, metering devices or rotary feeders, sufficient to distribute the finely conditioned loosefill insulation material into the airstream 33.

Referring again to FIG. 2, the finely conditioned loosefill insulation material is driven through the discharge mechanism 28 and through a machine outlet 32 by the airstream 33. The airstream 33 is provided by a blower 34 and associated ductwork, shown in phantom at 35. In alternate embodiments, the airstream 33 can be provided by other structures and manners, such as by a vacuum, sufficient to provide the airstream 33 through the discharge mechanism 28.

Referring again to FIG. 2, the low speed shredders 24a, 24b, agitator 26 and discharge mechanism 28 are mounted for rotation. In the illustrated embodiment, they are driven by an electric motor 36 and associated drive means (not shown). However, in other embodiments, the low speed shredders 24a, 24b, agitator 26 and discharge mechanism 28 can be driven by any suitable means. In still other embodiments, each of the low speed shredders 24a, 24b, agitator 26 and discharge mechanism 28 can be provided with its own source of rotation. In the illustrated embodiment, the electric motor 36 driving the low speed shredders 24a, 24b, agitator 26 and discharge mechanism 28 is configured to operate on a single 15 ampere, 110 volt a.c. electrical power supply. In other embodiments, other suitable power supplies can be used.

Referring again to FIG. 2, the discharge mechanism 28 is configured with a side inlet 92. The side inlet 92 is configured to receive the finely conditioned loosefill insulation material as it is fed in a substantially horizontal direction from the agitator 26. In this embodiment, the side inlet 92 of the discharge mechanism 28 is positioned to be horizontally adjacent to the agitator 26. In another embodiment, a low speed shredder 24a or 24b, or a plurality of low speed shredders 24a, 24b or agitators 26, or other shredding mechanisms can be horizontally adjacent to the side inlet 92 of the discharge mechanism 28 or in other suitable positions.

Referring again to FIG. 2, a choke 110 is positioned between the agitator 26 and the discharge mechanism 28. In this position, the choke 110 is configured to allow finely conditioned loosefill insulation material to enter the side inlet 92 of the discharge mechanism 28 and redirect heavier clumps of conditioned loosefill insulation material past the side inlet 92 of the discharge mechanism 28 and back to the low speed shredders, 24a and 24b, for further conditioning In the illustrated embodiment, the choke 110 has a substantially triangular cross-sectional shape. However, the choke 110 can have other cross-sectional shapes sufficient to allow finely conditioned loosefill insulation material to enter the side inlet 92 of the discharge mechanism 28 and redirect heavier clumps of conditioned loosefill insulation material past the side inlet 92 of the discharge mechanism 28 and back to the low speed shredders, 24a and 24b, for further conditioning

Referring again to FIG. 2, in operation, the inlet portion 16 of the chute 14 receives a package of compressed loosefill insulation material. As the package of compressed loosefill insulation material moves into the chute 14, the bale guide 19 urges the package against the cutting mechanism 20 thereby cutting an outer protective covering and allowing the compressed loosefill insulation within the package to expand. As the compressed loosefill insulation material expands within the chute 14, the chute 14 directs the expanding loosefill insulation material past the outlet portion 18 of the chute 14 and into the shredding chamber 23. The low speed shredders 24a, 24b receive the loosefill insulation material and shred, pick apart and condition the loosefill insulation material. The loosefill insulation material is directed by the low speed shredders 24a, 24b to the agitator 26. The agitator 26 is configured to finely condition the loosefill insulation material and prepare the loosefill insulation material for distribution into the airstream 33 by further shredding and conditioning the loosefill insulation material. The finely conditioned loosefill insulation material exits the agitator 26 and enters the discharge mechanism 28 for distribution into the airstream 33 provided by the blower 34. The airstream 33, entrained with the finely conditioned loosefill insulation material, exits the insulation blowing machine 10 at the machine outlet 32 and flows through the distribution hose 38 toward an insulation cavity.

Referring again to FIG. 3, the inlet portion 16 of the chute 14 includes longitudinal sides 64a, 64b and lateral sides 66a, 66b. The longitudinal sides 64a, 64b of the inlet portion 16 of the chute 14, are configured to be substantially vertical and centered about major longitudinal axis A-A. The lateral sides 66a, 66b are configured to be substantially horizontal and centered about major lateral axis B-B. In the illustrated embodiment, the package of compressed loosefill insulation material is fed into the inlet portion 16 of the chute 14 in a manner such that the package has a substantially vertical orientation. The term “vertical orientation”, as used herein, is defined to mean opposing major faces of the package are adjacent to the longitudinal sides 64a, 64b and opposing minor faces of the package are adjacent to the lateral sides 66a, 66b. Alternatively, the chute 14 can be configured such that the package has a substantially horizontal orientation when fed into the inlet end 16 of the chute 14.

Referring again to FIGS. 1 and 3, the loosefill insulation blowing machine 10, having a compact size and a reduced weight, is illustrated. The compact size and reduced weight of the blowing machine 10 provide a user with enhanced ability to transport and position the blowing machine 10 for increased efficiency during installation of conditioned loosefill insulation material. The term “compact size”, as used herein, is defined to mean the combined volumetric size of the lower unit 12 and the chute 14. The term “reduced weight”, as used herein, is defined to mean the combined weight of the lower unit 12 and the chute 14.

Referring again to FIGS. 1 and 3, the volumetric size of the lower unit 12 can be approximated as a cuboid having a width WLU, a height HLU and a depth DLU. In the illustrated embodiment, the width WLU is about 27.0 inches, the depth DLU is about 15.0 inches and the height HLU is about 25.5 inches. Accordingly, the volumetric size of the lower unit 12 is calculated to be 10,327.5 cubic inches or 6.0 cubic feet.

Referring again to FIGS. 1 and 3, volumetric size of the chute 14 can be approximated as a cuboid while adjusting (deducting) the volumetric size of a triangular prism (shown in phantom as 50) formed near the handle segment 17 and also deducting the volumetric size of the cuboid (shown in phantom as 52) formed at the base of the inlet portion 16 of the chute 14.

Referring again to FIGS. 1 and 3, the chute 14 has a width WC, a depth DC and a height HC. In the illustrated embodiment, the width WC is 34.0 inches, the depth DC is 11.0 inches and the height HC is 31.0 inches. Accordingly, the total unadjusted volume of the chute 14 is calculated to be 11,594.0 cubic inches or 6.7 cubic feet.

Referring again to FIGS. 1 and 3, the triangular prism 50 has a width WTP, a height HTP and a depth DTP. In the illustrated embodiment, the width WTP is 8.0 inches, the height HTP is 8.0 inches and the depth DTP is 11.0 inches. Accordingly, the volume of the triangular prism 50 is calculated to be 352.0 cubic inches or 0.2 cubic feet.

Referring again to FIGS. 1 and 3, the cuboid 52 has a width WCO, a height HCO and a depth DCO. In the illustrated embodiment, the width WCO is 7.7 inches, the height HCO is 10.0 inches and the depth DCO is 12.0 inches. Accordingly, the volume of the cut-out portion 52 is calculated to be 924.0 cubic inches or 0.5 cubic feet.

Referring again to FIGS. 1 and 3, the net volume of the chute 14, adjusting for the triangular prism 50 and the cuboid 52, is calculated to be 10,318.0 cubic inches or 6.0 cubic feet. Calculating the total volumetric size of the blowing machine 10 involves adding the volumetric size of the lower unit 12 with the net volumetric size of the chute 14, which equals 20,645.5 cubic inches or 12.0 cubic feet.

Without being held to the theory, it is believed the compact volumetric size of the blowing machine 10 results, in part, from the depth DLU of the lower unit 12 and depth DC of the chute 14 having a size that closely approximates the depth of the package of compressed loosefill insulation material.

Advantageously, the compact size of the blowing machine 10 provides a user with enhanced ability to transport the blowing machine 10 through small openings and narrow passages as may be found in typical buildings, residences and installations, such as for example, hallways, door openings and stairways. When transporting the blowing machine through such small openings and narrow passages, the blowing machine 10 can be oriented in a reclined position, with the blowing machine 10 resting on wheels 86. In a reclined position, the narrow profile of the blowing machine 10, as shown in FIG. 3, coupled with the overall compact size of the blowing machine advantageously allows users to be able to traverse small openings and narrow passages, thereby enabling the positioning the blowing machine in areas for increased efficiency during installation of conditioned loosefill insulation material.

Referring again to FIGS. 1 and 2, the weight of the blowing machine 10 is calculated as the weight of the lower unit 12 and the weight of the chute 14. The weight of the lower unit 12 includes, in part, the weight of the components located in the lower unit 12, including the low speed shredders 24a, 24b, agitator 26, discharge mechanism 28, the blower 34 and related ductwork 35, the motor 36 and related drive components (not shown) and the weight of the lower unit enclosure 70. In the illustrated embodiment, the weight of the lower unit 12 is in a range of from about 75.0 pounds to about 85.0 pounds.

Referring again to FIGS. 1 and 2, the weight of the chute includes, in part, the weight of the components located in the chute, including the handle segment 17, bale guide 19, the cutting mechanism and the weight of the distribution hose storage structure 80. In the illustrated embodiment, the weight of the chute is in a range of from about 15.0 pounds to about 25.0 pounds. Accordingly, the total weight of the blowing machine 10 is in a range of from about 90.0 pounds to about 110.0 pounds.

Advantageously, the reduced weight of the blowing machine 10 provides a user with enhanced ability to transport the blowing machine 10 over small projections and through small openings and narrow passages as may be found in typical buildings, residences and installations, such as for example, hallways, door openings and stairways. In a reclined position, the reduced weight of the blowing machine allows the user to easily balance the blowing machine 10, thereby enabling the positioning the blowing machine in areas for increased efficiency during installation of conditioned loosefill insulation material.

The principle and mode of operation of the loosefill insulation blowing machine having a compact size and reduced weight have been described in certain embodiments. However, it should be noted that the loosefill insulation blowing machine having a compact size and reduced weight may be practiced otherwise than as specifically illustrated and described without departing from its scope.

What is claimed is:

1. A machine for distributing blowing insulation material from a package of compressed loosefill insulation material, the machine comprising:
a chute having an inlet portion and outlet portion, the inlet portion configured to receive the package of compressed loosefill insulation material with the package having a substantially vertical orientation, the chute having a volumetric size; and
a lower unit configured to receive the compressed loosefill insulation material exiting the outlet portion of the chute, the lower unit including a plurality of shredders and a discharge mechanism, the discharge mechanism configured to discharge conditioned loosefill insulation material into an airstream, the lower unit having a volumetric size;
wherein the machine has a volumetric size equal to the total of the volumetric size of the chute and the volumetric size of the lower unit, and wherein the machine has a maximum volumetric size of 12.0 cubic feet.

2. The machine of claim 1, wherein the volumetric size of the chute comprises a handle segment, bale guide, cutting mechanism and a distribution hose storage structure.

3. The machine of claim 2, wherein the volumetric size of the chute is about 6.0 cubic feet.

4. The machine of claim 1, wherein the volumetric size of the lower unit comprises low speed shredders, agitator, discharge mechanism, blower and related ductwork, a motor and a lower unit enclosure.

5. The machine of claim 4, wherein the volumetric size of the lower unit is about 6.0 cubic feet.

6. The machine of claim 5, wherein the lower unit includes a quantity of two low speed shredders.

7. The machine of claim 1, wherein the chute is positioned vertically above the lower unit.

8. The machine of claim 1, wherein opposing longitudinal walls forming the inlet portion have a vertical orientation and opposing lateral walls forming the inlet portion have a horizontal orientation.

9. The machine of claim 1, wherein the lower unit includes an electric motor configured to drive a plurality of low speed shredders, an agitator and a discharge unit, and wherein the electric motor is further configured to operate on a single 15 ampere, 110 volt a.c. electrical power supply.

10. The machine of claim 1, wherein the chute has a depth of 11.0 inches.

11. The machine of claim 1, wherein the lower unit has a depth of 15.0 inches.

12. A machine for distributing blowing insulation material from a package of compressed loosefill insulation material, the machine comprising:
a chute having an inlet portion and outlet portion, the inlet portion configured to receive the package of compressed loosefill insulation material with the package having a substantially vertical orientation, the chute having a weight; and
a lower unit configured to receive the compressed loosefill insulation material exiting the outlet portion of the chute, the lower unit including a plurality of shredders and a discharge mechanism, the discharge mechanism configured to discharge conditioned loosefill insulation material into an airstream, the lower unit having a weight;
wherein the machine has a weight equal to the total of the weight of the chute and the weight of the lower unit, and wherein the machine has a maximum weight in a range of from about 90.0 pounds to about 110.0 pounds.

13. The machine of claim 12, wherein the weight of the chute comprises a handle segment, bale guide, cutting mechanism and a distribution hose storage structure.

14. The machine of claim 13, wherein the weight of the chute is in a range of from about 15.0 pounds to about 25.0 pounds.

15. The machine of claim 12, wherein the weight of the lower unit comprises low speed shredders, an agitator, a discharge mechanism, a blower and related ductwork, a motor and a lower unit enclosure.

16. The machine of claim 15, wherein the weight of the lower unit is in a range of from about 90.0 pounds to about 110.0 pounds.

17. The machine of claim 12, wherein the lower unit includes a quantity of two low speed shredders.

18. The machine of claim 12, wherein the chute is positioned vertically above the lower unit.

19. The machine of claim 12, wherein opposing longitudinal walls forming the inlet portion have a vertical orientation and opposing lateral walls forming the inlet portion have a horizontal orientation.

20. The machine of claim 12, wherein the lower unit includes an electric motor configured to drive a plurality of low speed shredders, an agitator and a discharge unit, and wherein the electric motor is further configured to operate on a single 15 ampere, 110 volt a.c. electrical power supply.
